(19) United States
(12) Patent Application Publication
(10) Pub. No.: US 2024/0326378 A1
(43) Pub. Date: Oct. 3, 2024

(54) MULTILAYER COMPOSITE WITH NONWOVEN TOUGHENING

(71) Applicant: Dow Global Technologies LLC, Midland, MI (US)

(72) Inventors: Zheng Zhang, Shanghai (CN); Kunpeng Guo, Shanghai (CN); Shijie Ren, Shanghai (CN); Hongjie Han, Shanghai (CN)

(73) Assignee: Dow Global Technologies LLC, Midland, MI (US)

(21) Appl. No.: 18/290,975

(22) PCT Filed: Jul. 26, 2021
(86) PCT No.: PCT/CN2021/108422

§ 371 Date: Jan. 22, 2024

(51) Int. Cl. B32B 5/26; B32B 38/00; B32B 38/08

(52) U.S. Cl. CPC B32B 5/265; B32B 38/08; B32B 2038/0076; B32B 2250/03; B32B 2250/20; B32B 2260/021; B32B 2260/046; B32B 2262/124; B32B 2309/68

(57) ABSTRACT

Embodiments of the present disclosure am directed to multilayer thermoset composites which comprise a first fabric reinforcement layer, a nonwoven fabric, and a second fabric reinforcement layer. The nonwoven fabric may be positioned between the first fabric reinforcement layer and the second fabric reinforcement layer. A thermoset resin may at least partially permeate the first fabric reinforcement layer, the nonwoven fabric, and the second fabric reinforcement layer. The thermoset resin may be an epoxy, unsaturated polyester, or polyurethane. The first and second fabric reinforcement layer may each comprise one or more of glass fiber, carbon fiber, polyaramid fiber, polyethylene fiber, or basalt fiber. The nonwoven fabric may be formed from bicomponent fibers having a sheath/core configuration. The sheath may be formed from ethylene-carboxylic acid copolymers, or ionomers of ethylene-carboxylic acid copolymers. Further embodiments include methods of making the multilayer thermoset composite.

### TECHNICAL FIELD

Embodiments of the present disclosure generally relate to multilayer composites, and more specifically, to thermoset multilayer composite structures with nonwoven layers.

### BACKGROUND

Thermoset composites generally exhibit high strength, low density, and high stiffness. Accordingly, they are widely used in aircraft, aerospace, automotive, high-speed trains, wind power blades, sports gear, high pressure gas tanks, and many other applications which require high strength and low weight. However, they are often excessively brittle. Accordingly, in many composite materials, especially for laminated fabrics, impact resistance in the thickness direction is often insufficient.

The most common failure mode of thermoset composites is believed to be delamination between the fabric layers. The layers are generally held together only by the resin, with insufficient reinforcement of composite in the thickness direction. Without reinforcement, after impacts cracks spread quickly through the crosslinked resin, causing delamination.

Various methods have been used to toughen thermoset composites. For example, three-dimensional weaving, Z-pining, weft knitted fabrics, three-dimensional textiles, have all been attempted. However, these technologies add complexity and cost to the composite manufacturing process.

Accordingly, there remains a need for composite structures which can provide sufficient impact strength across all axes without increasing manufacturing complexity.

### SUMMARY

Embodiments of the present disclosure address this need by providing multilayer thermoset composites comprising a nonwoven fabric toughening layer, multiple fabric reinforcement layers, and a thermoset resin at least partially permeated through the layers. Embodiments further address methods of making the multilayer thermoset composites of the present disclosure. These thermoset composites provide improved mechanical properties, particularly impact strength across the transverse axis, relative to conventional composites.

In one embodiment, a multilayer thermoset composite may comprise a first fabric reinforcement layer, a nonwoven fabric, and a second fabric reinforcement layer. The nonwoven fabric may be positioned between the first fabric reinforcement layer and the second fabric reinforcement layer. A thermoset resin may at least partially permeate the first fabric reinforcement layer, the nonwoven fabric, and the second fabric reinforcement layer. The thermoset resin may be an epoxy, unsaturated polyester, or polyurethane. The first fabric reinforcement layer may comprise one or more of glass fiber, carbon fiber, polyaramid fiber, polyethylene fiber, or basalt fiber. The second fabric reinforcement layer may comprise one or more of glass fiber, carbon fiber, polyaramid fiber, polyethylene fiber, or basalt fiber. The nonwoven fabric may be formed from bicomponent fibers having a sheath/core configuration. The sheath may be formed from ethylene-carboxylic acid copolymers, or ionomers of ethylene-carboxylic acid copolymers.

In another embodiment, a process for forming a thermoset composite comprises at least partially permeating a dry multilayer composite with a thermoset resin to form a wet, uncured composite; and curing the wet, uncured composite to form a thermoset composite. The dry multilayer composite may comprise a first fabric reinforcement layer, a nonwoven fabric, and a second fabric reinforcement layer. The first fabric reinforcement layer may comprise one or more of glass fiber, carbon fiber, polyaramid fiber, polyethylene fiber, or basalt fiber. The second fabric reinforcement layer may comprise one or more of glass fiber, carbon fiber, polyaramid fiber, polyethylene fiber, or basalt fiber. The nonwoven fabric may be formed from bicomponent fibers having a sheath/core configuration, wherein the sheath is formed from ethylene-carboxylic acid copolymers, or ionomers of ethylene-carboxylic acid copolymers.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing and the following description describes various embodiments and are intended to provide an overview or framework for understanding the nature and character of the claimed subject matter. The accompanying figure is included to provide a further understanding of the various embodiments, and are incorporated into and constitute a part of this specification.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic illustration of the thermoset composite of one or more embodiments of the present disclosure.

FIG. 2 is a schematic illustration of the thermoset composite of further embodiments of the present disclosure.

### DETAILED DESCRIPTION

Embodiments of the present disclosure address the need for impact strength across all axes by providing multilayer thermoset composites and methods of making such composites. These composites may include a nonwoven fabric, multiple fabric reinforcement layers, and a thermoset resin. Without being limited by theory, it is believed that reactive groups on the fibers of the nonwoven fabric may react with the thermoset resin and result in a stronger bond, relative to nonwoven fabrics without reactive groups.

### Definitions

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

As used herein, the term “ionomer” refers to a polymeric compound having at least some ionic groups, ionizable groups, or both.

The term “polymer” refers to a polymeric compound prepared by polymerizing monomers, whether of the same or a different type. The generic term polymer thus embraces the terms “homopolymer” and “copolymer.” The term “homopolymer” refers to polymers prepared from only one type of monomer; the term “copolymer” refers to polymers prepared from two or more different monomers, and for the purpose of this disclosure may include “terpolymers” and “interpolymer.” Trace amounts of impurities (for example, catalyst residues) may be incorporated into and/or within the polymer. A polymer may be a single polymer or a polymer blend.

As used herein, “gsm” and “g/m²” mean grams per square meter, “min.”/“mins.” mean minutes; “hr.”/“hrs.” mean hours; “sec.” means seconds; “mol.” means moles, “mol. %” means mole percent, “wt. %” means weight percent, “mbar” means millibar, “MPa” means megapascals, “kJ/m²” means kilojoules per square meter, “g/cm³” means grams per cubic centimeter, “in.” means inches, “° C.” means degrees Celsius, “mm” means millimeters, “S/m” means Siemens per meter, “μm” means micrometers, “cP” means centipoise.

### Embodiments

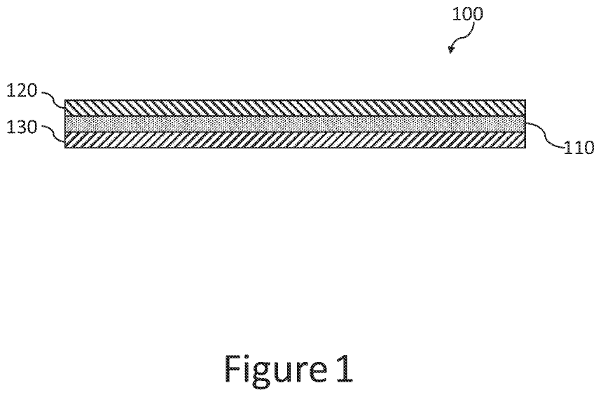

Referring now to FIG. 1, a multilayer thermoset composite 100 may comprise a first fabric reinforcement layer 120, a second fabric reinforcement layer 130, a nonwoven fabric 110 positioned between the first fabric reinforcement layer 120 and the second fabric reinforcement layer 130. The multilayer thermoset composite 100 may further comprise a thermoset resin which at least partially permeates the first fabric reinforcement layer 120, the nonwoven fabric 110, and the second fabric reinforcement layer 130.

The nonwoven fabric 110 may be thermoplastic. It is believed that a thermoset multilayer composite comprising a thermoplastic nonwoven fabric layer may have improved toughness relative to a thermoset multilayer composite without a thermoplastic nonwoven fabric layer.

The nonwoven fabric 110 may be prepared by any type of nonwoven fabric produced through various techniques. For example, the nonwoven fabric may be spunbond nonwoven fabric, melt-blown nonwoven fabric, staple nonwoven fabric, or flashspun nonwoven fabric. According to some exemplary embodiments, the nonwoven fabric may be a spunbond nonwoven fabric.

As used herein, a “spunbond nonwoven fabric” is a nonwoven fabric prepared in one continuous process, whereby fibers are spun and then directly dispersed into a web by either deflectors or air streams. Spunbond nonwoven fabrics may be bonded thermally, with a resin, or by hydro-entanglement.

As used herein, “permeates” means to penetrate below the surface of each layer. Thus, when the thermoset resin at least partially permeates the first fabric reinforcement layer 120, the nonwoven fabric 110, and the second fabric reinforcement layer 130, the resin penetrates below the surface of each of those layers.

The nonwoven fabric 110 may be positioned between the first fabric reinforcement layer 120 and the second fabric reinforcement layer 130. According to some embodiments, the nonwoven fabric 110 may be in direct contact with the first fabric reinforcement layer 120 and the second fabric reinforcement layer 130. According to alternate embodiments, the first fabric reinforcement layer 120 may not be in direct contact with the nonwoven fabric 110. Similarly, the nonwoven fabric 110 may not be in direct contact with the second fabric reinforcement layer 130 i.e., there are intervening layers there-between. One or more additional layers may be present between the fabric reinforcement layers and the nonwoven fabric 110.

According to some embodiments, the nonwoven fabric 110 may take up at least 70%, at least 80%, at least 90%, at least 95%, or at least 99% of the entire surface area of the first fabric reinforcement layer 120 and the second fabric reinforcement layer 130. Accordingly, the first fabric reinforcement layer 120 may not touch the second fabric reinforcement layer 130 over more than 10% of its surface area.

The nonwoven fabric 110 may be formed from bicomponent fibers having a sheath/core configuration. The term “bicomponent fiber” may refer to a fiber comprising a pair of polymer compositions intimately adhered to each other along the length of the fiber. The pair of polymer compositions may form the sheath-core configuration in cross-section. The bicomponent sheath-core configuration may be round, trilobal, pentalobal, octalobal, dumbbell-shaped, island in the sea shaped, or star shaped in cross section. In all these configurations, the core may be positioned in the interior and may be surrounded by the sheath, both of which may extend substantially the entire length of the fiber.

The bicomponent fibers may have an average fiber diameter of from 1 μm to 100 μm. For example, the bicomponent fibers may have an average fiber diameter of from 2 μm to 50 μm, from 2 μm to 90 μm, from 5 μm to 75 μm, from 5 μm to 50 μm, from 10 μm to 40 μm, or any subset thereof.

The bicomponent fibers may be continuous fibers. The term “continuous fiber” refers to a fiber of indefinite or extreme length. In practice, there may be one or more breaks in the “continuous fiber” due to manufacturing concerns, but a “continuous fiber” is distinguishable from a “staple fiber” as staple fibers are cut to a predetermined length while continuous fibers are not. Continuous fibers may have an average fiber length of at least 0.1 in, at least 0.25 in, at least 0.5 in, at least 1 in, at least 2 in, at least 3 in, at least 4 in, at least 5 in, or even at least 6 in.

The sheath may have a melting point lower than that of the core. For example, the sheath may have a melting point at least 5° C., at least 10° C., at least 20° C., at least 40° C., or even at least 60° C. lower than the melting point of the core.

The nonwoven fabric 110 may have a basis weight of from 10 g/m² to 1000 g/m². As used herein, “basis weight” refers to the mass per surface area of a sheet of material. In some examples, the nonwoven fabric 110 may have a basis weight of from 50 g/m² to 1000 g/m², from 100 g/m² to 1000 g/m², from 10 g/m² to 500 g/m², from 10 g/m² to 100 g/m², from 50 g/m² to 100 g/m², from 10 g/m² to 50 g/m² or any subset thereof.

The nonwoven fabric 110 may have an average thickness of from 0.1 mm to 10 mm. For example, the nonwoven fabric 110 may have an average thickness of from 0.1 mm to 8 mm, from 0.1 mm to 5 mm, from 0.1 mm to 1 mm, from 1 mm to 10 mm, from 1 mm to 5 mm, from 3 mm to 8 mm, or any subset thereof.

To achieve the preferred thickness, the nonwoven fabric 110 may comprise multiple layers of nonwoven fabric 110. For example, the nonwoven fabric 110 may comprise at least 1, 2, 3, 4, 5, 10, 15, 20, or more than 20 layers of nonwoven fabric 110. The layers of nonwoven fabric 110 may be hot-pressed together or simply placed atop one another before being combined into the thermoset multilayer composite.

The nonwoven fabric 110 may comprise bicomponent fibers. The bicomponent fibers may comprise a sheath and a core. The sheath of the bicomponent fibers may be formed from ethylene-carboxylic acid copolymers, or ionomers of ethylene-carboxylic acid copolymers. The core of the bicomponent fibers may be formed from polyamide.

The bicomponent fiber may be from 10 wt. % to 60 wt. % sheath. For example, the bicomponent fiber may be from 10 wt. % to 50 wt. %, from 10 wt. % to 40 wt. %, from 10 wt. % to 30 wt. %, from 20 wt. % to 60 wt. %, from 20 wt. % to 50 wt. %, from 20 wt. % to 40 wt. %, from 30 wt. % to 60 wt. %, from 30 wt. % to 50 wt. %, from 30 wt. % to 45 wt. %, from 40 wt. % to 50 wt. %, or any subset thereof, of sheath.

The sheath of the bicomponent fibers may comprise at least 80 wt. % of the ethylene-carboxylic acid copolymers or ionomers thereof. For example, the sheath may comprise at least 85 wt. %, at least 90 wt. %, at least 95 wt. %, at least 99 wt. %, or even at least 99.99 wt. % of the ethylene-carboxylic acid copolymers or ionomers thereof.

In some embodiments, the carboxylic acid may be acrylic acid or methacrylic acid. In some exemplary embodiments, the carboxylic acid is methacrylic acid. The sheath of the bicomponent fibers may comprise from 70 wt. % to 99 wt. % of ethylene monomer. It should be understood that the “ethylene monomer” may be incorporated into a polymer, such as the ethylene-carboxylic acid copolymers or ionomers thereof. For example, the sheath may comprise from 80 wt. % to 99 wt. %, from 70 wt. % to 90 wt. %, from 80 wt. % to 90 wt. %, from 90 wt. % to 99 wt. %, or any subset thereof, of ethylene monomer.

Various acid contents are contemplated for the ethylene-carboxylic acid copolymers, or ionomers of ethylene-carboxylic acid copolymers. For example, the ethylene-carboxylic acid copolymers or ionomers of ethylene-carboxylic acid copolymers may have an acid content of from 1 wt. % to 20 wt. %, from 1 wt. % to 15 wt. %, from 1 wt. % to 10 wt. %, from 1 wt. % to 5 wt. %, from 5 wt. % to 20 wt. %, from 5 wt. % to 15 wt. %, from 5 wt. % to 10 wt. %, from 10 wt. % to 20 wt. %, from 10 wt. % to 15 wt. %, from 15 wt. % to 20 wt. %, or any subset thereof.

The at least a portion of the acid groups of the ethylene-carboxylic acid copolymers, or ionomers thereof, may be neutralized. According to some embodiments, these acid groups may be neutralized with cations, such as Zn cations, Na cations, K cations, Ca cations, Mg cations, or a combination thereof.

Various cation neutralization levels of the sheath are contemplated. For example, the sheath may have a cation neutralization level of from 0.1 mol. % to 60 mol. %. As used herein, the “cation neutralization level” of the sheath refers to the percentage of acid groups in the sheath, which are neutralized with a cation. It should be understood that the moles referred to in calculating the “mol. %” are the moles of acid groups. In some embodiments, the sheath may have a cation neutralization level of from 1 mol. % to 60 mol. %, from 5 mol. % to 60 mol. %, from 10 mol. % to 60 mol. %, from 20 mol. % to 60 mol. %, from 40 mol. %, to 60 mol. %, from 0.1 mol. % to 60 mol. %, from 0.1 mol. % to 40 mol. %, from 0.1 mol. % to 20 mol. %, from 0.1 mol. % to 10 mol. %, from 0.1 mol. % to 1 mol. %, from 5 mol. % to 50 mol. %, from 10 mol. % to 40 mol. %, from 10 mol. % to 30 mol. %, or any subset thereof.

The ethylene-carboxylic acid copolymers, or ionomers thereof, may have a melt flow rate (MFR) of from 12 g/10 min to 60 g/10 min. For example, the MFR may be from 12 g/10 min to 45 g/10 min, from 12 g/10 min to 30 g/10 min, from 20 g/10 min to 60 g/10 min, from 20 g/10 min to 40 g/10 min, from 40 g/10 min to 60 g/10 min, or any subset thereof. The MFR may be measured in accordance with ASTM D1238 at 190° C. with a 2160 g load. It is believed that a higher melt flow rate, within the specified range, enables easier processing.

Suitable ionomers of ethylene/carboxylic acid copolymers include SURLYN™ ionomer resin available from Dow, Inc (Midland, MI).

The ionomer may have a density of from 0.950 to 0.980 g/cc. For example, the ionomer may have a density of from 0.950 to 0.970 g/cc, from 0.950 to 0.960 g/cc, from 0.960 to 0.980 g/cc, from 0.960 to 0.970 g/cc, from 0.970 to 0.980 g/cc, or any combination thereof.

Without being limited by theory, it is believed that the acidic reactive groups in the sheath of the bicomponent fibers improve interfacial bonding energy and thus improve toughening performance. In contrast, standard polyester, polyamide, and polypropylene nonwovens lack these reactive groups and thus have insufficient bond strength with the present resins.

The core of the bicomponent fiber may comprise polyamide. Polyamides may be polymers which comprise recurring amide (—CONH—) groups. For example, the core of the bicomponent fiber may comprise one or more of polyamide 6, polyamide 11, polyamide 12, polyamide 66, polyamide 610, polyamide 612, polyamide 66/610, polyamide 666, polyamide 6/69, nylon 1010, nylon 1012, PA 6T, or blends thereof. Commercially available polyamides may include Zytel® resin, available from DuPont.

The sheath and/or core of the bicomponent fiber may include other additives. For example, the sheath and/or core may include dyes, pigments, antioxidants, ultraviolet stabilizers, spin finishes and other conventional additives.

Without being limited by theory, it is believed that a nonwoven fabric 110 constructed in a single component, that is only the ethylene-carboxylic acid copolymer or ionomer thereof, would lack sufficient mechanical strength, especially at elevated temperatures, to serve in the desired applications. However, it is believed that the present bicomponent nonwoven can provide sufficient mechanical strength at both high and low temperatures.

The spunbond nonwoven fabric 110 may be prepared using conventional spinbonding methods, such as those disclosed in WO2019/084774.

The first fabric reinforcement layer 120 may comprise one or more of glass fiber, carbon fiber, polyaramid fiber, polyethylene fiber, or basalt fiber. The second fabric reinforcement layer 130 may comprise one or more of glass fiber, carbon fiber, polyaramid fiber, polyethylene fiber, or basalt fiber.

The first and second fabric reinforcement layers 120, 130 may each independently comprise at least 90 wt. %, at least 95 wt. %, at least 99 wt. %, or even at least 99.9 wt. % of the glass fiber, carbon fiber, polyaramid fiber, polyethylene fiber, or basalt fiber, and any thermoset resin which has permeated the fabric reinforcement layers.

The first and second fabric reinforcement layers may have a basis weight of from 10 gsm to 10,000 gsm. For example, the first and second fabric reinforcement layers may have a weight of from 10 gsm to 1,000 gsm, from 100 gsm to 10,000 gsm, from 100 gsm to 1,000 gsm, or any subset thereof.

The first and second fabric reinforcement layers may each comprise unidirectionally oriented fabric, biaxially oriented fabric, or both. It should be understood that the first and second fabric reinforcement layers may, but need not, comprise fabrics of the same orientation.

The fabric reinforcement layers may have a thickness average thickness of from 0.1 mm to 10 mm. For example, the fabric reinforcement layers may have an average thickness of from 0.1 mm to 8 mm, from 0.1 mm to 5 mm, from 0.1 mm to 1 mm, from 1 mm to 10 mm, from 1 mm to 5 mm, from 3 mm to 8 mm, or any subset thereof.

A thermoset resin may at least partially permeate the first fabric reinforcement layer 120, the nonwoven fabric 110, and a second fabric reinforcement layer 130.

The thermoset resin may be an epoxy, unsaturated polyester, or polyurethane. The resin may be flowable in the temperature range from 23° C. to 70° C. For example, the viscosity of the resin between 23° C. and 70° C. may be from 0.1 cP to 1000 cP, from 0.1 cP to 500 cP, from 0.1 cP to 300 cP, from 1 cP to 1000 cP, from 1 cP to 800 cP, from 1 cP to 500 cP, from 1 cP to 300 cP, from 10 cP to 1000 cP, from 10 cP to 800 cP, from 10 cP to 500 cP, from 10 cP to 300 cP, from 100 cP to 1000 cP, from 100 cP to 500 cP, or any subset thereof.

The first fabric reinforcement layer 120, the nonwoven fabric 110, and the second fabric reinforcement layer 130 may together have a thermoset resin content of from 10 wt. % to 50 wt. %. For example, the composite may have a thermoset resin content of from 10 to 40 wt. %, from 20 to 50 wt. %, from 30 to 50 wt. %, or any subset thereof.

The thermoset resin may be curable. The thermoset resin may be thermally cured, chemically cured, or both. The thermoset resin may thermally cure at temperatures of from 40° C. to 500° C., from 40° C. to 100° C., from 40° C. to 80° C., from 60° C. to 500° C., 60° C. to 100° C., or any subset thereof.

The multilayer thermoset composite 100 may further comprise a resin hardener. The resin hardener may react with the resin or other components of the multilayer thermoset composite 100 to cause the resin to cure faster. The ratio of the weight of resin to the total weight of resin and resin hardener may be from 50 wt. % to 100 wt. %, from 60 wt. % to 90 wt. %, from 70 wt. % to 80 wt. %, or any subset thereof. Suitable combinations of resin and hardener may include Airstone™ 760 epoxy resin and Airstone 766™ epoxy hardener (both available from Olin™ Epoxy) in a ratio of 100/33.

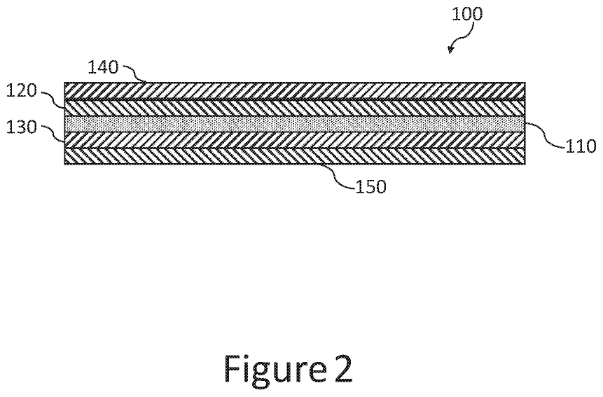

Referring now to FIG. 2, the multilayer thermoset composite 100 may comprise additional layers, such as additional layers of fabric reinforcement. For example, the multilayer thermoset composite 100 may comprise a third fabric reinforcement layer 150. The third fabric reinforcement layer 150 may be positioned on the opposite side of the first fabric reinforcement layer 120 from the nonwoven fabric 110 layer. The third fabric reinforcement layer 150 may have a different fiber orientation from the first fabric reinforcement layer 120.

The multilayer thermoset composite 100 may comprise a fourth fabric reinforcement layer 140. The fourth reinforcement layer 140 may be positioned on the opposite side of the second fabric reinforcement layer 130 from the nonwoven fabric 110 layer. The fourth fabric reinforcement layer 140 may have a different fiber orientation from the second fabric reinforcement layer 130.

A process for forming a multilayer thermoset composite 100 may comprise at least partially permeating a dry multilayer composite with a thermoset resin to form a wet, uncured composite; and curing the wet, uncured composite to form a thermoset composite. The dry multilayer composite may comprise the first fabric reinforcement layer 120, the nonwoven fabric 110, and the second fabric reinforcement layer 130, as described above.

The process for forming a thermoset composite may further include optionally pressing the dry multilayer composite to form a dry multilayer composite.

At least partially permeating the dry multilayer composite with a thermoset resin may comprise placing the dry multilayer composite into a mold, and injecting a thermoset resin into the mold. At least partially permeating the dry multilayer composite with a thermoset resin may be accomplished using resin transfer molding (RTM) or vacuum assisted resin transfer molding (VARTM).

Curing the wet, uncured composite may comprise heating the wet, uncured composite to at least 50° C. for 3 hours. For example, the wet, uncured composite may be cured at a temperature of at least 60° C. or at least 70° C. for at least 3 hours, at least 4 hours, at least 5 hours, or at least 6 hours.

The process for forming a thermoset composite may further include subjecting the wet, multilayer composite to a vacuum. The vacuum may be applied before and/or during the curing step. The vacuum may be from 0 mbar to 20 mbar, from 5 mbar to 20 mbar, from 10 mbar to 20 mbar, from 0 mbar to 15 mbar, from 5 mbar to 15 mbar, or any subset thereof.

The presence of the vacuum may cause resin to flow across the dry multilayer composite to form the wet, multilayer composite. The resin and multilayer composite may then be sealed inside a vacuum bag together. The vacuum may also help to drive the resin into the multilayer composite.

### TEST METHODS

### Mode I Interlaminar Fracture Toughness (G_{Ic})

The Mode I interlaminar fracture toughness (G_{Ic}) of each composite sheet sample was tested according to ASTM D5528-13. The samples were tested using the double cantilever beam (DCB) in an INSTRON 5969 Universal testing system. The testing speed was set at 5 mm/min. The sample size was 125 mm×25 mm×4 mm, with one side of initial delamination by polyvinylidene fluoride resin (“PVDF”) film (13 μm) inserted in the center layer, an initial delamination length was approximately 50 mm from the edge. Before testing, the samples were balanced in the lab at 23° C. and 50% relative humidity for more than 48 hours. Each recorded measurement is the average of 6 specimens.

Mode I was calculated according to the Modified Beam Theory (MBT) method. The beam theory expression for the strain energy release rate of a perfectly built-in (that is, clamped at the delamination front) double cantilever beam is described by Equation 1.

$$G 1 c = \frac{3 P δ}{2 b a} \qquad Equation 1$$

where:
P=load,
δ=load point displacement,
b=specimen width, and
a=delamination length.

### Mode II Interlaminar Fracture Toughness (G_{IIc})

The Mode II interlaminar fracture toughness (G_{IIc}) of composite sheet sample was tested following ASTM D7905-19, using the end-notched flexure (ENF) test. The sample size was 160 mm×25 mm×4 mm, with one side of initial delamination by PVDF film (13 um) inserted in the center layer, an initial delamination length was approximately 50 mm from the edge. Before testing, the samples were balanced in the lab at 23° C. and 50% relative humidity for more than 48 hours. Each recorded measurement is the average of 6 specimens. The measurements were calculated using Equation 2.

$${G}_{IIC} = {G}_{Q} = \frac{3 m {P}_{max}^{2} {a}_{0}^{2}}{2 B} \qquad Equation 2$$

where m is the CC coefficient, P_{Max} is the maximum force from the fracture test, a₀ is the crack length used in the fracture test, B is the specimen width, and other variables are as described above.

### Flexural Strength and Modulus

Flexural Strength and modulus were measured according to ISO 14125.

### Density

Density was measured according to ASTM D792.

### Barcol Hardness

Barcol hardness was measured according to ASTM D2583.

### Melt Flow Rate

The MFR was measured according to ASTM D1238 at 190° C. with a 2160 g load.

### Fiber Content

The reinforcing fiber content of the entire sample was measured according to ASTM D3171-15, method A8.

### EXAMPLES

A series of inventive and comparative examples were prepared in accordance with some embodiments of the present disclosure. A listing of the raw materials used is given in Table 1. Unless otherwise indicated all samples were 500 mm×500 mm sheets. The release film was 250 mm×500 mm. Release film may be used to ensure that a sample fails in the proper layer during testing. Accordingly, although release film was present in the test samples, it is an optional component.

TABLE 1
Material list

| | | Chemical Description, | |
|---|---|---|---|
| Ingredient | Product | Chemical formula, or | |
| Type | Name | Structure | Source |
| Reinforcement | Carbon | 120 gsm 0°/90° biaxial | Jiangsu |
| fiber | fiber | carbon fiber fabric | Aosheng |
| | mat A | | composite |
| Reinforcement | Carbon | UD 618 gsm | SAERTEX |
| fiber | fiber | (unidirectional | GmbH & Co. |
| | mat B | non-crimp fabric) | KG |
| Thermoset | Epoxy | Airstone ® 760 epoxy | Olin Epoxy |
| resin | | resin/766 epoxy hardener | |
| Thermoplastic | Ionomer/ | SURLYN ™ AD8545, | DOW |
| nonwoven | polyamide | 100 gsm nonwoven | |
| | nonwoven | | |
| Thermoplastic | Polyamide | PA-6, 40 gsm nonwoven | Pu Sheng |
| nonwoven | nonwoven A | | Fabric |
| Thermoplastic | Polyamide | PA-6, 180 gsm | Pu Sheng |
| nonwoven | nonwoven B | nonwoven | Fabric |

### Inventive Example 1 (IE1)

A series of fabrics were laid in a mold to form a dry multilayer composite of the present disclosure in the following order:
1: Three layers of biaxial carbon fiber fabric A.
2: Two layers of unidirectional carbon fiber fabrics B.
3. A layer of ionomer/polyamide nonwoven.
4: A layer of release film.
5: Two layers of unidirectional carbon fiber fabric B.
6: Three layers of biaxial carbon fiber fabric A.
7: A piece of peel ply.
8: A flow mesh.

### Comparative Example 1 (CE1)

A carbon fiber/epoxy composite without nonwoven toughening was prepared according to the following method. A series of fabrics were laid in a mold to form a dry multilayer composite in the following order:
1: Three layers of biaxial carbon fiber fabric A.
2: Two layers of unidirectional carbon fiber fabric B.
3: A layer of release film.
4: Two layers of unidirectional carbon fiber fabric B.
5: Three layers of biaxial carbon fiber fabric A.
6: A piece of peel ply.
7: A flow mesh.

### Comparative Example 2 (CE2)

A carbon fiber/epoxy composite with one layer of polyamide nonwoven A as toughening layer was prepared according to the following method. A series of fabrics were laid in a mold to form a dry multilayer composite in the following order:
1: Three layers of biaxial carbon fiber fabric A.
2: Two layers of unidirectional carbon fiber fabric B.
3. A layer of polyamide nonwoven A.
4: A layer of release film.
5: Two layers of unidirectional carbon fiber fabric B.
6: Three layers of biaxial carbon fiber fabric A.
7: A piece of peel ply.
8: A flow mesh.

### Comparative Example 3 (CE3)

A carbon fiber/epoxy composite with one layer of polyamide nonwoven B as toughening layer was prepared according to the following method. A series of fabrics were laid in a mold to form a dry multilayer composite in the following order:
1: Three layers of biaxial carbon fiber fabric A.
2: Two layers of unidirectional carbon fiber fabric B.
3. A layer of polyamide nonwoven B.
4: A layer of release film.
5: Two layers of unidirectional carbon fiber fabric B.
6: Three layers of biaxial carbon fiber fabric A.
7: A piece of peel ply.
8: A flow mesh.

### Pressing, Sealing, and Curing

An injection hose with a length of 300 mm was placed next to the flow mesh on one side of the sample and a vacuum outlet was placed on the far side of the sample. Two loops of adhesive sealing strips were stuck around each layer laid in the mold. Then, the dry multilayer composite was sealed with two layers of vacuum bag film.

The resin was transferred into the dry multilayer composite using the VARTM method. Specifically, a vacuum pump was connected to the above-mentioned vacuum outlet and the system was pressurized to a vacuum of 0 to 20 mbar. The resin system (Airstone 760 epoxy resin/Airestone 766 epoxy hardener=100/33, resin hardener mixture) was degassed under vacuum for 5 min. to remove any bubbles. Once the resin was degassed, it was connected to the injection hose and the vacuum pressure caused it to flow through the flow mesh and across the surface of the sample. The resin inlet was sealed and the pressure differential across the surface of the vacuum bag drove the resin into the sample.

Once completed, the wet sample was cured by heating at 70° C. for 6 hours. After curing, the product was removed from the mold. Auxiliary materials such as peel plies and flow meshes were removed, and the laminate was cut into specimens.

### Results

Table 2 discloses the Mode I and Mode II interlaminar fracture toughness of each of the inventive and comparative examples.

TABLE 2

| Property | Testing Method | CE1 | CE2 | CE3 | IE1 |
|---|---|---|---|---|---|
| Mode I interlaminar fracture | ASTM D5528-13 | 0.62 | 3.18 | 3.51 | 3.98 |
| toughness (G_{IC}) (kJ/m²) | (MBT Method) | | | | |
| Mode II interlaminar fracture | ASTM D7905-19 | 2.25 | 2.46 | 1.30 | 4.13 |
| toughness (G_{IIC}) (kJ/m²) | (ENF Method) | | | | |
| Flexural strength (MPa) | ISO 14125 | 810.8 | 804.6 | 550.7 | 837.1 |
| Flexural Modulus (MPa) | ISO 14125 | 58.5 | 56.0 | 56.5 | 56.6 |
| Density (g/cm³) | ASTM D792 | 1.490 | 1.479 | 1.503 | 1.469 |
| Barcol Hardness | ASTM D2583 | 70 | 70 | 69 | 69 |
| Fiber Content (wt. %) | ASTM D3171-15 | 66.6 | 61.7 | 63.4 | 63.1 |
| | (A8 method) | | | | |

According to either the Mode I or Mode II interlaminar fracture toughness, the inventive examples perform significantly better than the comparative examples. The significant deficiencies of CE1 under Mode I is believed to be caused by the lack of a nonwoven bicomponent toughening layer.

The inventive and comparative samples showed similar results for other material properties, such as density, hardness, flexural strength, and flexural modulus. This indicates that the present composite toughening process has minimal negative impact on the other mechanical properties.

One exception being the low flexural strength of sample CE3. It is believed that the 30% drop in flexural strength of CE3, relative to CE1, is due to an overly dense thermoplastic nonwoven in the composite. It is believed that this density may lead to insufficient penetration of the epoxy resin.

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A multilayer thermoset composite comprising:
a first fabric reinforcement layer comprising one or more of glass fiber, carbon fiber, polyaramid fiber, polyethylene fiber, or basalt fiber;
a nonwoven fabric formed from bicomponent fibers having a sheath/core configuration, wherein the sheath is formed from ethylene-carboxylic acid copolymers, or ionomers of ethylene-carboxylic acid copolymers; and
a second fabric reinforcement layer comprising one or more of glass fiber, carbon fiber, polyaramid fiber, polyethylene fiber, or basalt fiber; wherein:
a thermoset resin at least partially permeates the first fabric reinforcement layer, the nonwoven fabric, and a second fabric reinforcement layer,
the thermoset resin is an epoxy, unsaturated polyester, or polyurethane; and
the nonwoven fabric is positioned between the first fabric reinforcement layer and the second fabric reinforcement layer.

2. The multilayer thermoset composite of claim 1, wherein the nonwoven fabric is a spunbond nonwoven fabric.

3. The multilayer thermoset composite of claim 1, wherein
the sheath comprises an ionomer of ethylene-carboxylic acid copolymers with a cation neutralization level of from 0.1 mol. % to 60 mol. %.

4. The multilayer thermoset composite of claim 1, wherein the sheath is neutralized with Zn cations, Na cations, or both.

5. The multilayer thermoset composite of claim 1, wherein the ethylene-carboxylic acid copolymers, or ionomers of ethylene-carboxylic acid copolymers have a carboxylic acid content of from 1 wt. % to 20 wt. %.

6. The multilayer thermoset composite of claim 1, wherein the ethylene-carboxylic acid copolymers, or ionomers of ethylene-carboxylic acid copolymers have a melt flow rate (MFR) from 12 g/10 min to 60 g/10 min, as measured in accordance with ASTM D1238 at 190° C. with a 2160 g load.

7. The multilayer thermoset composite of claim 1, wherein the bicomponent fibers have an average fiber diameter of from 1 μm to 100 μm.

8. The multilayer thermoset composite of claim 1, wherein the bicomponent fibers are continuous fibers.

9. The multilayer thermoset composite of claim 1, wherein the core comprises polyamide.

10. A process for forming a thermoset composite, the process comprising:
at least partially permeating a dry multilayer composite with a thermoset resin to form a wet, uncured composite; and
curing the wet, uncured composite to form a multilayer thermoset composite, wherein the dry multilayer composite comprises:
a first fabric reinforcement layer comprising one or more of glass fiber, carbon fiber, polyaramid fiber, polyethylene fiber, or basalt fiber;
a nonwoven fabric formed from bicomponent fibers having a sheath/core configuration, wherein the sheath is formed from ethylene-carboxylic acid copolymers, or ionomers of ethylene-carboxylic acid copolymers; and
a second fabric reinforcement layer comprising one or more of glass fiber, carbon fiber, polyaramid fiber, polyethylene fiber, or basalt fiber.

11. The process of claim 10, wherein the nonwoven fabric is a spunbond nonwoven fabric.

12. The process of claim 10, further comprising pressing the dry multilayer composite to form a dry multilayer composite.

13. The process of claim 10, wherein at least partially permeating the dry multilayer composite with a thermoset resin comprises:
placing the dry multilayer composite into a mold, and
injecting a cross-linkable liquid resin into the mold.

14. The process of claim 10, wherein curing the wet, uncured composite comprises heating the wet, uncured composite to at least 50° C. for 3 hours.

15. The process of claim 10, further comprising subjecting the wet, multilayer composite to a vacuum.
